(19) United States
(12) Patent Application Publication
(10) Pub. No.: US 2016/0132911 A1
(43) Pub. Date: May 12, 2016

(54) SI IMAGE REACTION INVESTIGATION SYSTEM AND INVESTIGATION METHOD THEREOF

(71) Applicant: DAEHAN A&C CO., LTD., Seoul (KR)

(72) Inventors: Chul Dae Han, Seoul (KR); Jee Hee BAEK, Seoul (KR)

(21) Appl. No.: 14/899,565

(22) PCT Filed: Jul. 5, 2013
(86) PCT No.: PCT/KR2013/005995

§ 371 Date: Dec. 18, 2015

(30) Foreign Application Priority Data
Jun. 26, 2013 (KR) 10-2013-0073384

(51) Int. Cl. G06Q 30/02

(52) U.S. Cl. CPC G06Q 30/0203

(57) ABSTRACT

The present invention provides a store identity (SI) image response research system, including: at least one consumer member terminal; at least one corporate member terminal; and an SI image response research server connected to the consumer member terminal and the corporate member terminal, providing a survey service for researching a consumer demand on an SI image design to the consumer member terminal, and providing at least one SI image design proposal created by reflecting a reply from the survey service or a consumer demand based on the reply to a corresponding one of the corporate member terminals, wherein the survey service provided by the SI image response research server includes a survey item for researching a consumer choice for a design element which matches a business category and less than a predetermined number of image adjectives representing a store personality which are registered by the corporate member terminal.

### TECHNICAL FIELD

Exemplary embodiments relate to a store identity (SI) image response research system and a research method thereof, and more particularly, to an SI image response research system and a research method thereof in which a consumer response to or a consumer demand on an SI image design is researched online so as to facilitate the development of an SI image design desired by consumers.

### BACKGROUND ART

Store identity (SI) refers to a process of unifying a store image of a company, and is considered a strategy of arousing a consumer interest by unifying or standardizing a store sign, an interior design, a displaying style, lightings, and the like, based on a brand image of the company. One of the significant factors in SI image design development is a consumer response. However, due to the absence of a system for researching a consumer response to or consumer demand on an SI image design and providing consumer-preferred image data, there is difficulty in developing an SI image design desired by target consumers.

### DISCLOSURE OF INVENTION

### Problem to be Solved by the Invention

The invention is conceived to satisfy the aforementioned needs, and exemplary embodiments of the invention provide a store identity (SI) image response research system and a research method thereof in which a consumer response to or a consumer demand on an SI image design is researched online so as to facilitate the development of an SI image design desired by consumers.

However, the invention should not be construed as being limited to the exemplary embodiments set forth herein, and rather, these exemplary embodiments are provided so that this disclosure will fully convey the scope of the invention to those skilled in the art.

### Means for Solving Problem

According to an exemplary embodiment of the invention, a store identity (SI) image response research system, includes: at least one consumer member terminal; at least one corporate member terminal; and an SI image response research server connected to the consumer member terminal and the corporate member terminal, providing a survey service for researching a consumer demand on an SI image design to the consumer member terminal, and providing at least one SI image design proposal created by reflecting a reply from the survey service or a consumer demand based on the reply to a corresponding one of the corporate member terminals, wherein the survey service provided by the SI image response research server includes a survey item for researching a consumer choice for a design element which matches a business category and less than a predetermined number of image adjectives representing a store personality which are registered by the corporate member terminal.

The SI image response research server may further provide a survey service for researching a consumer response to an SI image design proposal created by the SI image response research server and provided to the corporate member terminal or an SI image design proposal self-created by a corporate member, and the SI image design proposal self-created by the corporate member may be a proposal prior to researching a consumer demand or a proposal reflecting a reply subsequent to researching a consumer demand.

The SI image response research server may include a questionnaire construction module enabling the corporate member terminal to construct and modify a questionnaire so as to store the questionnaire in a questionnaire database, and register the business category and the image adjective.

The SI image response research server may include a questionnaire construction module enabling the corporate member terminal to construct and modify a questionnaire so as to store the questionnaire in a questionnaire database, and register the SI image design proposals.

The SI image response research server may further include a questionnaire sending/collecting module extracting a questionnaire of a corresponding corporate from the questionnaire database and sending out the questionnaire to a corresponding target consumer member terminal when receiving a request for a survey from the corporate member terminal, and collecting a completed questionnaire when the questionnaire is completed in the consumer member terminal.

The questionnaire construction module may present a plurality of image adjectives so as to allow the corporate member terminal to selectively register the image adjective, and the SI image response research server may further include an image adjective module performing an editing function such as modifying, adding, and/or deleting the image adjective presented to the corporate member terminal, and storing and managing the plurality of image adjectives presented to the corporate member terminal in an image adjective database.

The SI image response research server may present a plurality of image design elements so as to allow the consumer member terminal to select the image design element at the time of conducting a survey service for researching the consumer demand, and may further include an image design element module performing an editing function such as modifying, adding, and/or deleting the plurality of image design elements presented to the consumer member terminal, and storing and managing the plurality of image design elements presented to the consumer member terminal in an image design element database.

The SI image response research server may further include an analysis module analyzing a reply from the survey service based on the collected questionnaire.

The SI image response research server may further include a member type classification module classifying consumer members or corporate members stored in a registered member database into types, and filtering the stored members to identify a survey target member through interworking with the questionnaire sending/collecting module.

The SI image response research server may further include a display module processing the questionnaire stored in the questionnaire database to be displayed on the consumer member terminal prior to being sent to the consumer member terminal.

The SI image response research server may include a point saving module automatically saving a point for each member as a reward in a case of joining membership or participating in a survey, and when one of the saved points is used, deducting the corresponding point.

The SI image response research server may include an information dissemination module allowing for a purchase of information through interworking with a payment module requesting and conducting a payment, and the information may include at least one SI image design proposal created by reflecting a reply from the survey service, or a consumer demand based on the reply.

According to an exemplary embodiment of the invention, a research method of an SI image response research system, the research method includes: providing a survey service for researching a consumer demand on an SI image design to a consumer member terminal connected to a network; and providing at least one SI image design proposal created by reflecting a reply from the survey service or a consumer demand based on the reply to a corresponding corporate member terminal connected to the network, wherein the survey service includes a survey item for researching a consumer choice for a design element which matches a business category and less than a predetermined number of image adjectives representing a store personality which are registered by the corporate member terminal.

The research method may further include providing a survey service for researching a consumer response to an SI image design proposal provided to the corporate member terminal or an SI image design proposal self-created by a corporate member, wherein the SI image design proposal self-created by the corporate member is a proposal prior to researching a consumer demand, or a proposal reflecting a reply subsequent to researching a consumer demand.

The research method may further include enabling the corporate member terminal to construct and modify a questionnaire so as to store the questionnaire in a questionnaire database, and register the business category and the image adjective at the time of constructing the questionnaire.

The research method may further include enabling the corporate member terminal to construct and modify a questionnaire so as to store the questionnaire in a questionnaire database, and register the SI image design proposal at the time of constructing the questionnaire.

The providing of the survey service may include: extracting a questionnaire of a corresponding corporate from the questionnaire database and sending out the questionnaire to a corresponding target consumer member terminal when receiving a request for a survey from the corporate member terminal; and collecting a completed questionnaire when the questionnaire is completed in the consumer member terminal.

The research method may further include presenting a plurality of image adjectives so as to allow the corporate member terminal to selectively register the image adjective, at the time of constructing the questionnaire.

The research method may further include presenting a plurality of image design elements so as to allow the consumer member terminal to selectively register the image design element, at the time of conducting the survey service for researching the consumer demand.

The research method may further include analyzing a reply from the survey service based on the collected questionnaire.

The research method may further include classifying registered consumer members or corporate members into types, and filtering the registered members to identify a survey target member.

The research method may further include processing the questionnaire stored in the questionnaire database to be displayed on the consumer member terminal prior to being sent to the consumer member terminal.

The research method may further include automatically saving a point for each member by providing the point as a reward in a case of joining membership or participating in a survey, and when one of the saved points is used, deducting the corresponding point.

The research method may further include requesting and conducting a payment in a case of providing, to the corporate member terminal, at least one SI image design proposal created by reflecting a reply from the survey service, or a consumer demand based on the reply.

### Effect of the Invention

According one or more exemplary embodiments of the invention, a store identity (SI) image response research system and a research method thereof may conduct an online research into a consumer response to or a consumer demand on an SI image design so as to facilitate the development of an SI image design desired by consumers.

### BRIEF DESCRIPTION OF DRAWINGS

FIG. 1 is a diagram illustrating a store identity (SI) image response research system according to an exemplary embodiment.

FIG. 2 is a block diagram illustrating an internal configuration of an SI image response research server of FIG. 1.

FIGS. 3A to 3M are views illustrating a series of processes of constructing a questionnaire for researching a consumer demand on an SI image design.

FIGS. 4A to 4S are views illustrating processes of creating a webpage of a questionnaire for researching a consumer demand on an SI image design.

FIG. 5 is a view illustrating an example of a questionnaire sent to a consumer member in the form of e-mail.

FIG. 6 is a flowchart illustrating a research method of an SI image response research system according to an exemplary embodiment.

FIG. 7 is a flowchart illustrating a research method of an SI image response research system according to another exemplary embodiment.

### BEST MODE(S) FOR CARRYING OUT THE INVENTION

Advantages and features of the invention and methods for achieving them will be made clear from exemplary embodiments described below in detail with reference to the accompanying drawings. The invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. The invention is merely defined by the scope of the claims. Therefore, well-known constituent elements, operations and techniques are not described in detail in the exemplary embodiments in order to prevent the invention from being obscurely interpreted. Like reference numerals refer to like elements throughout the specification.

Hereinafter, a store identity (SI) image response research system and a research method thereof according to an exemplary embodiment will be described with reference to accompanying drawings.

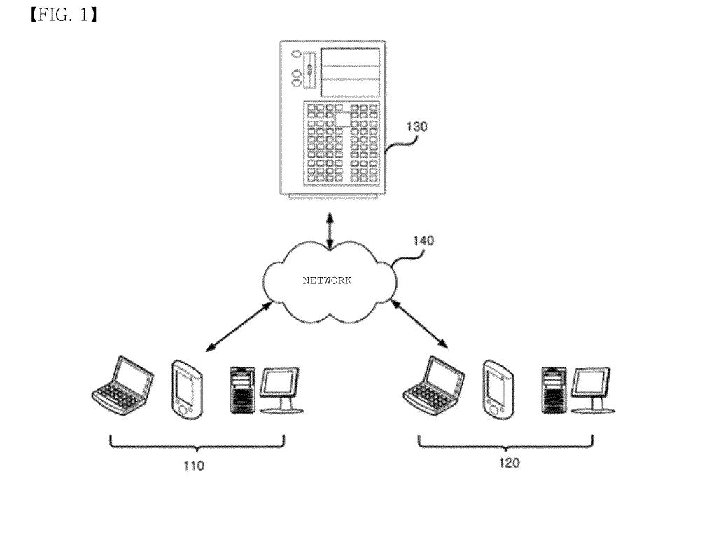

FIG. 1 is a diagram illustrating a store identity (SI) image response research system according to an exemplary embodiment.

Referring to FIG. 1, the SI image response research system includes at least one consumer member terminal 110, at least one corporate member terminal 120, and an SI image response research server 130.

The consumer member terminal 110, the corporate member terminal 120, and the SI image response research server 130 may be connected to one another through a network 140. For example, the network 140 may be the Internet.

The consumer member terminal 110 and the corporate member terminal 120 are terminals owned by consumer members or corporate members registered in the SI image response research server 130. For example, the consumer member terminal 110 and the corporate member terminal 120 may include a personal computer (PC), a tablet PC, a laptop, a smartphone, and the like, which are connectable through the network 140.

The SI image response research server 130 is connected to the consumer member terminal 110 and the corporate member terminal 120 through the network 140, provides a survey service for researching a consumer demand on an SI image design to the consumer member terminal 110, and provides at least one SI image design proposal created by reflecting a reply from the survey service or a consumer demand based on the reply to a corresponding one of the corporate member terminals 120. The survey service provided by the SI image response research server 130 includes a survey item for researching a consumer demand on a design element (e.g., a color, a material, a line shape, lightings, and the like) that matches a business category registered by the corporate member terminal 120, and less than a predetermined number of image adjectives (e.g., “romantic”, “classic”, “modern”, “relaxed”, “flashy”, “retro”, and the like) that represent a store personality. Further, when the image adjectives, of which the number is predetermined by the corporate member terminal 120, are registered in the SI image response research server 130, the priority thereof may be set. When the SI image response research server 130 provides the survey service to the consumer member terminal 110, the less than the predetermined number of image adjectives registered according to the priority and the business category are presented so as to allow the consumer member terminal 110 to select a design element that matches the presented image adjective and the business category from among a plurality of design elements, according to the priority, corresponding to the predetermined number. A series of the survey services of the SI image response research server 130 may be provided to the consumer member terminal 110 in the form of an application.

The SI image response research server 130 may further provide a survey service for researching a consumer response to an SI image design proposal. In this incident, the SI image design proposal may be a proposal created by the SI image response research server 130 and provided to the corporate member terminal 120, or a proposal self-created by the corporate member terminal 120. In addition, the SI image design proposal self-created by the corporate member terminal 120 may be a proposal prior to researching a consumer demand, or a proposal reflecting a reply subsequent to researching a consumer demand.

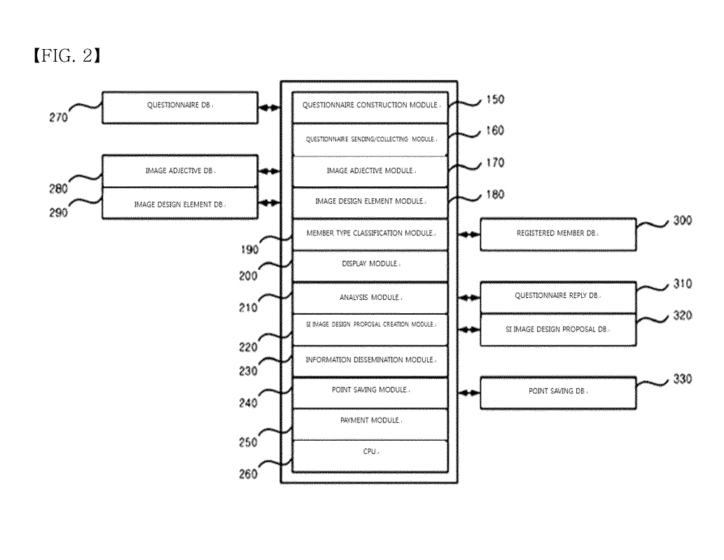

FIG. 2 is a block diagram illustrating an internal configuration of the SI image response research server 130 of FIG. 1.

The SI image response research server 130 may include a questionnaire construction module 150, a questionnaire sending/collecting module 160, an image adjective module 170, an image design element module 180, a member type classification module 190, a display module 200, an analysis module 210, an SI image design proposal creation module 220, an information dissemination module 120, a point saving module 140, a payment module 250, a central processing unit (CPU) 260, a survey database 270, an image adjective database 280, an image design element database 290, a registered member database 300, a survey reply database 310, an SI image design proposal database 320, and a point saving database 330.

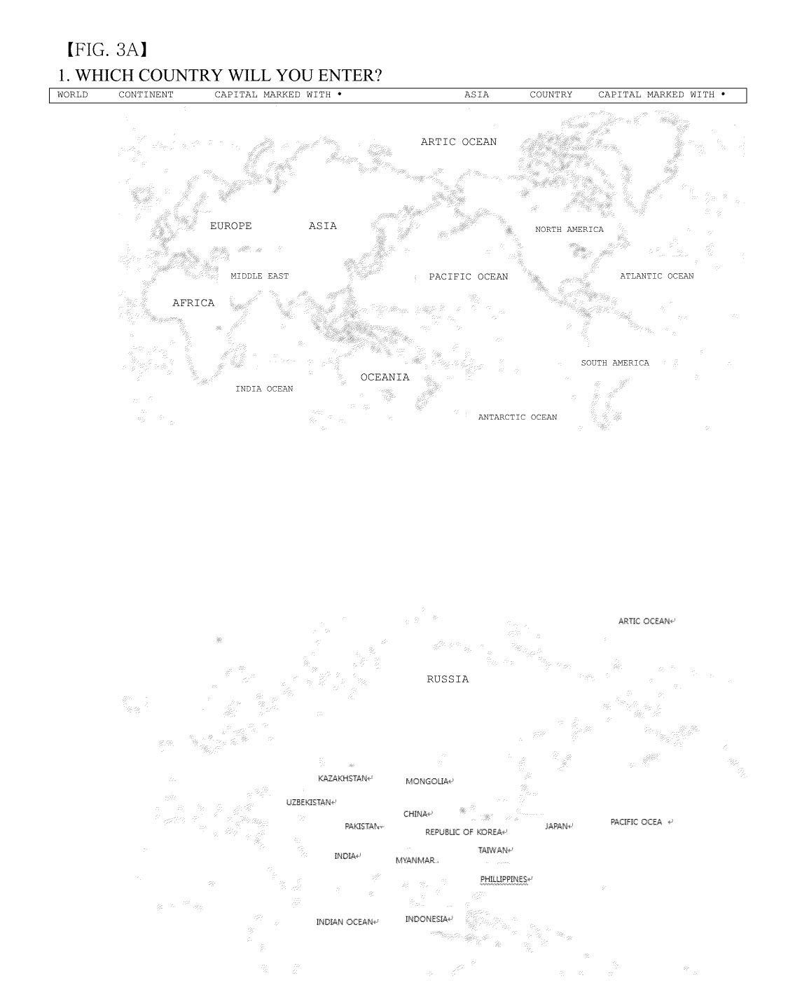

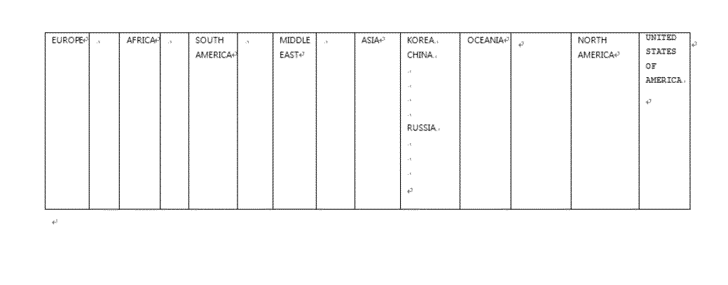

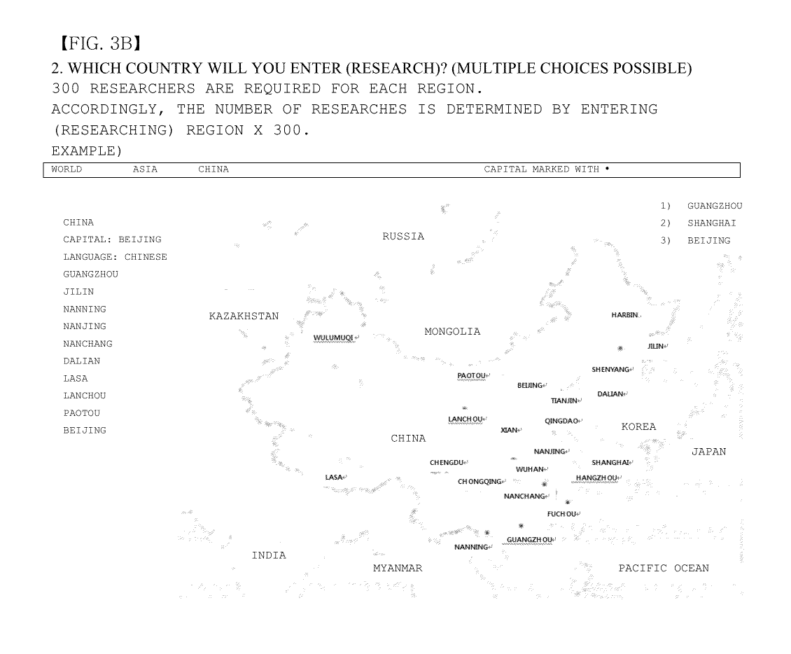

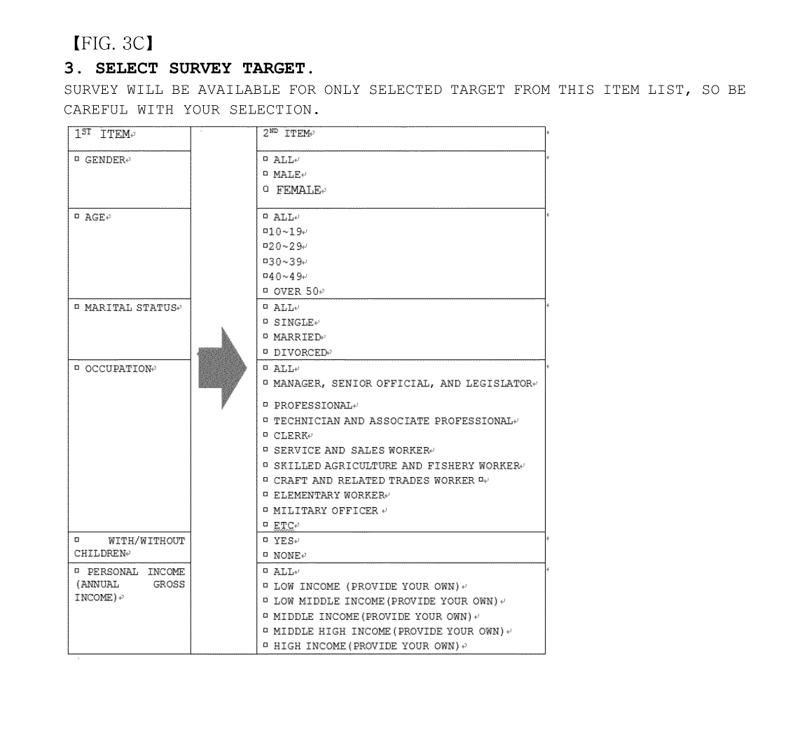

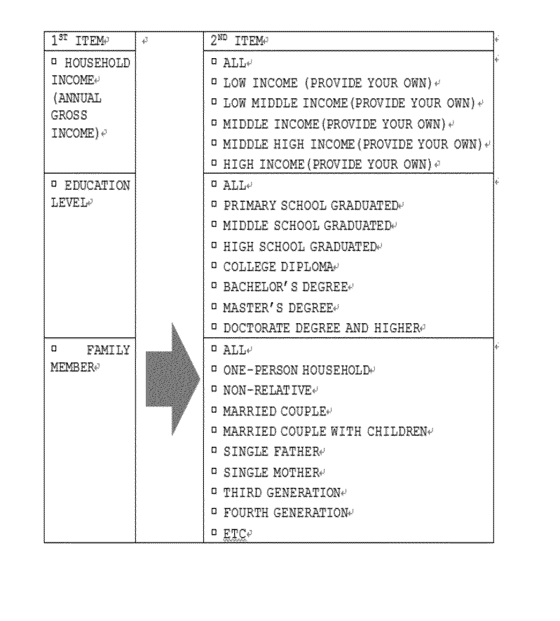

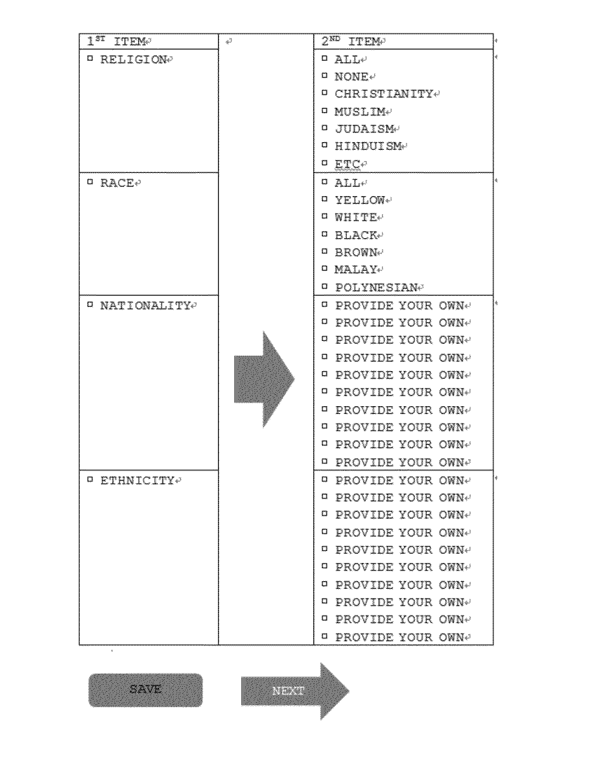

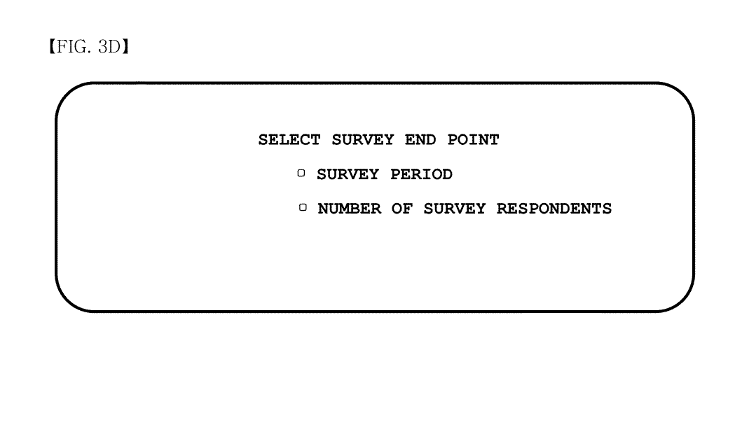

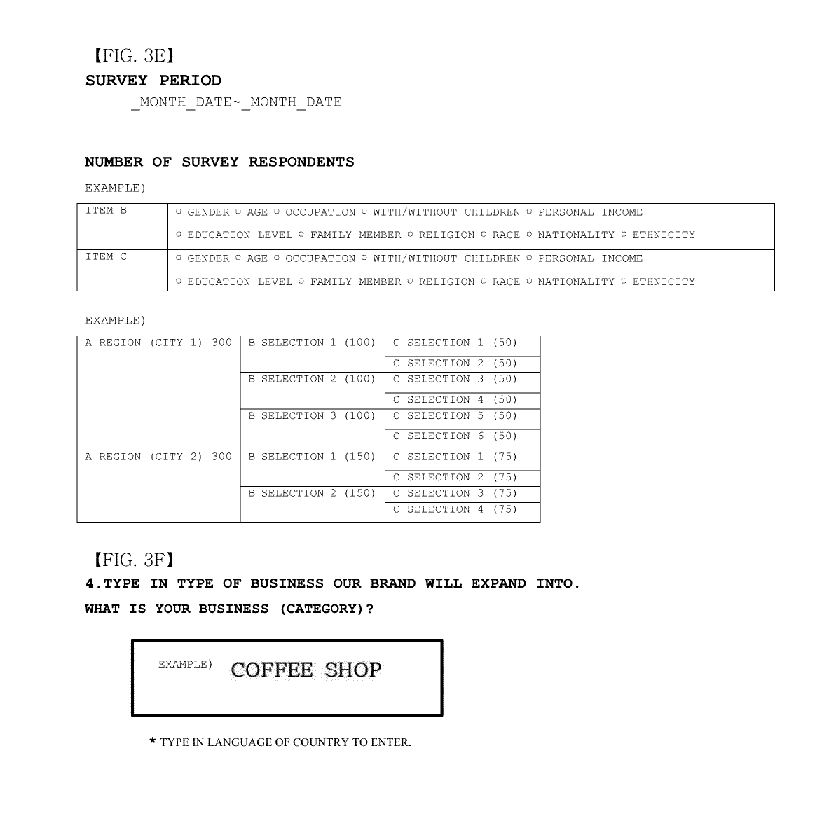

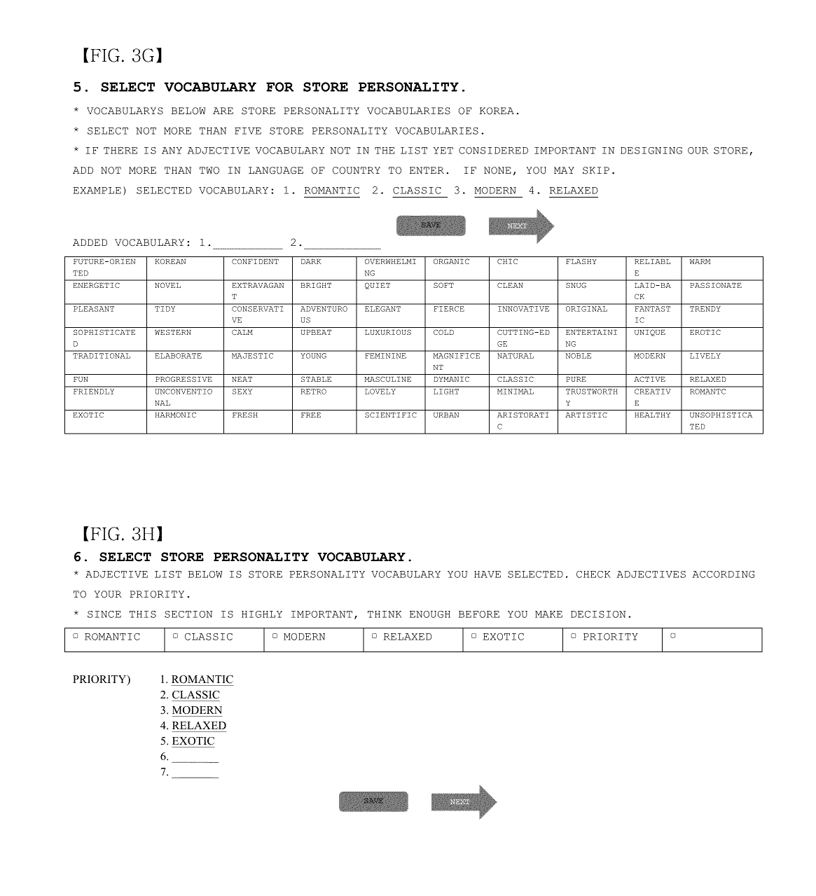

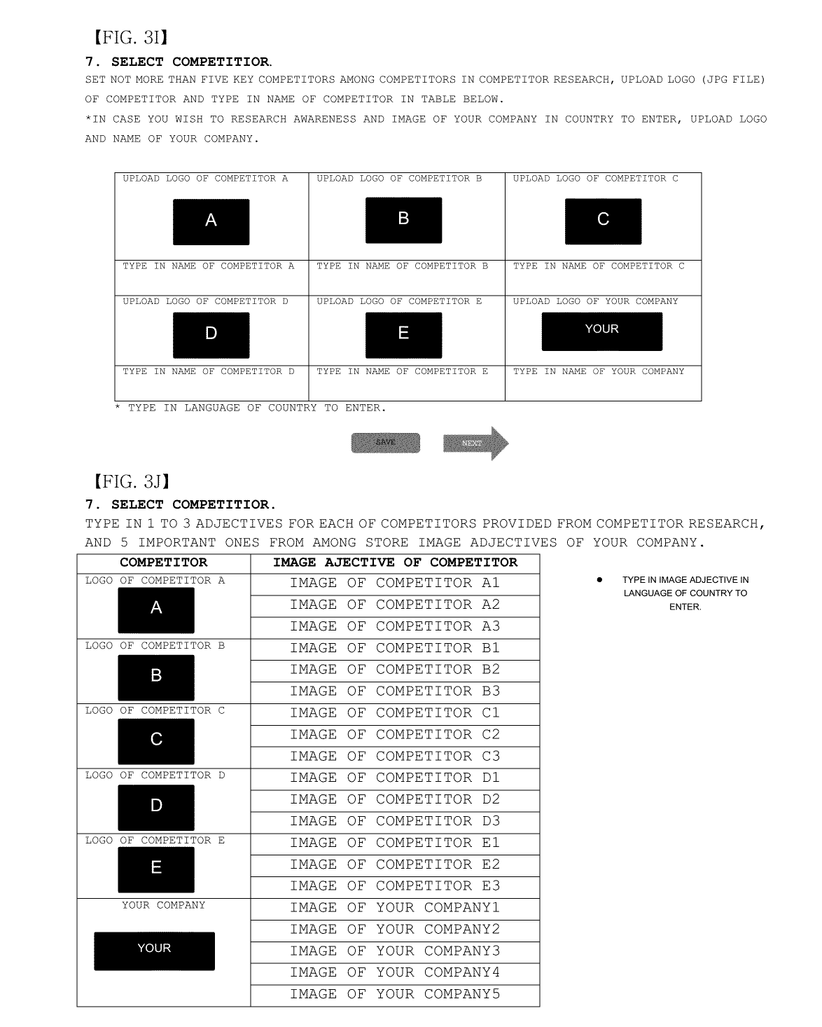

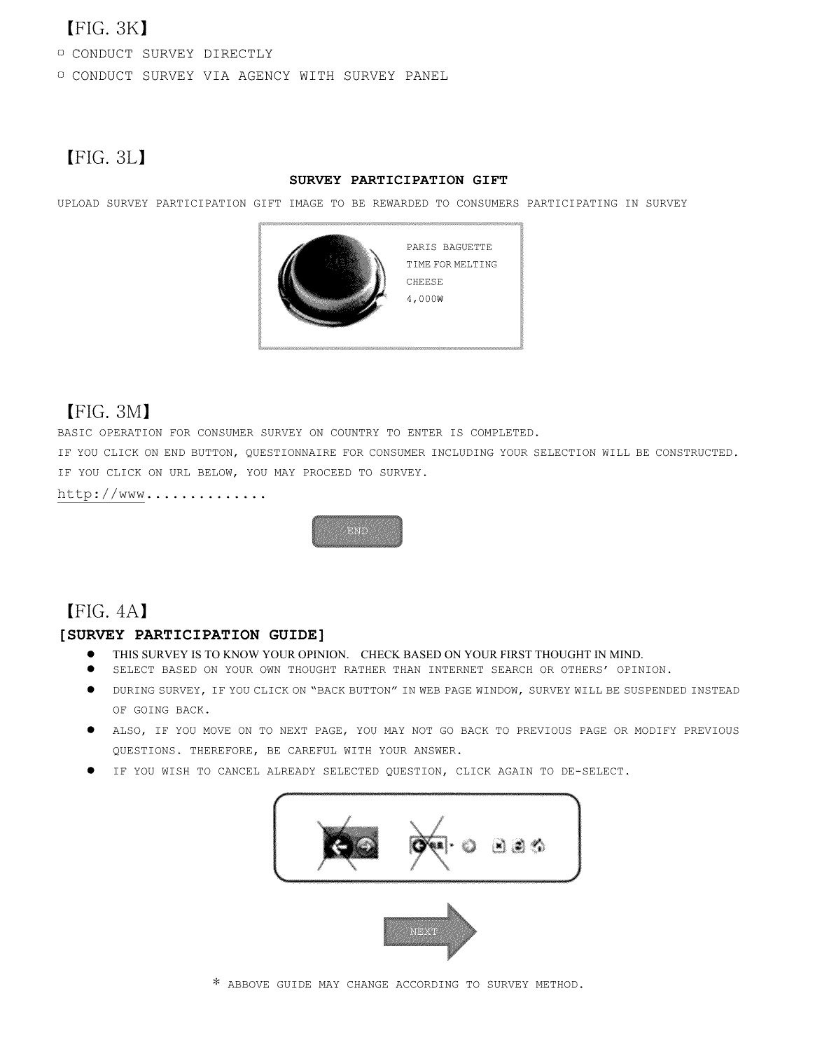

The questionnaire construction module 150 is a module that allows the corporate member terminal 120 that is connected to the SI image response research server 130 to construct and modify a questionnaire for conducting a survey service. FIGS. 3A to 3M are views illustrating a series of processes of constructing a questionnaire for researching a consumer demand on an SI image design. As illustrated in FIGS. 3A to 3M, the questionnaire construction module 150 may construct a survey item desired by a corporate member through processes of selecting a country and a city for the corporate member to enter, setting a survey target (gender, age, marital status, occupation, with/without children, personal income, household income, education level, family member, religion, race, nationality, ethnicity, and the like), choosing when to finish the survey (selecting from survey time period and survey respondents number), type in a business category (provided in the language of the target country to enter), selecting an image adjective representing a store personality and verifying the priority thereof, selecting a competitor, typing in image adjectives of the company and the competitor, uploading an image of a reward gift for a consumer participating in the survey, and the like. A questionnaire for researching a consumer demand on an SI image design, a questionnaire for researching a consumer response to an SI image design proposal, or a questionnaire in combination of the above two may be constructed based on the survey item. At the time of constructing the questionnaire for researching a consumer response on an SI image design proposal, a corporate member may be allowed to register the SI image design proposal.

The questionnaire constructed by the questionnaire construction module 150 is stored in the questionnaire database 270 for each corporate member to be managed.

Although it is exemplified that the business category and the image adjective of the corporate member are registered when the questionnaire construction module 150 constructs a questionnaire, the business category and the image adjective of the corporate member may also be registered in the SI image response research server 130 at the time of membership sign-up. In this case, the business category and the image adjective of the corporate member registered at the time of membership sign-up may be stored in the registered member database 300 to be managed. In a case of needing to modify the registered business category and the image adjective, the corporate member may click on a menu such as a ‘modify member information’, so as to modify information managed in the registered member database 300.

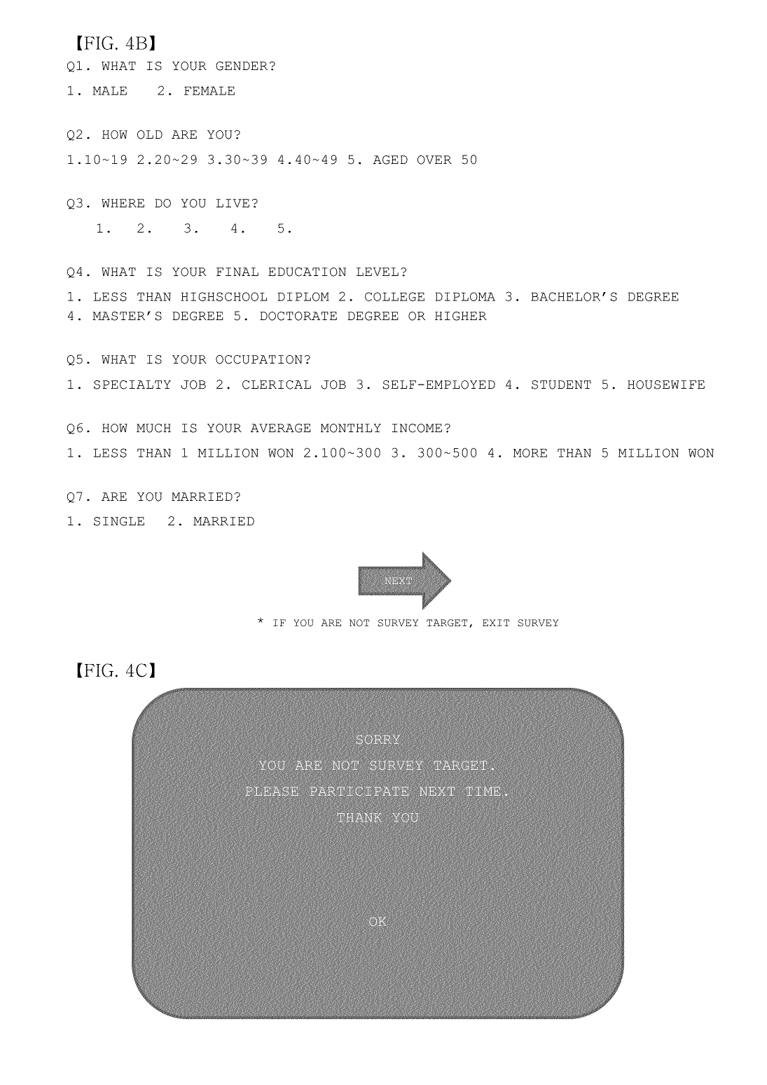

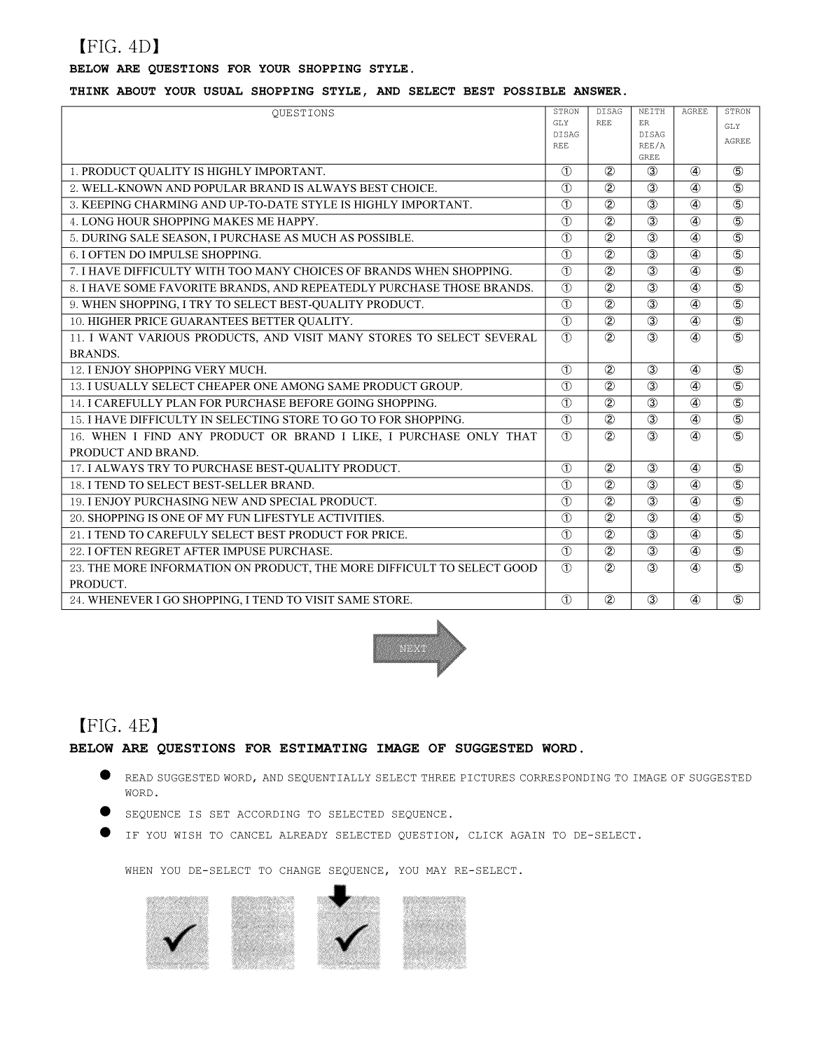

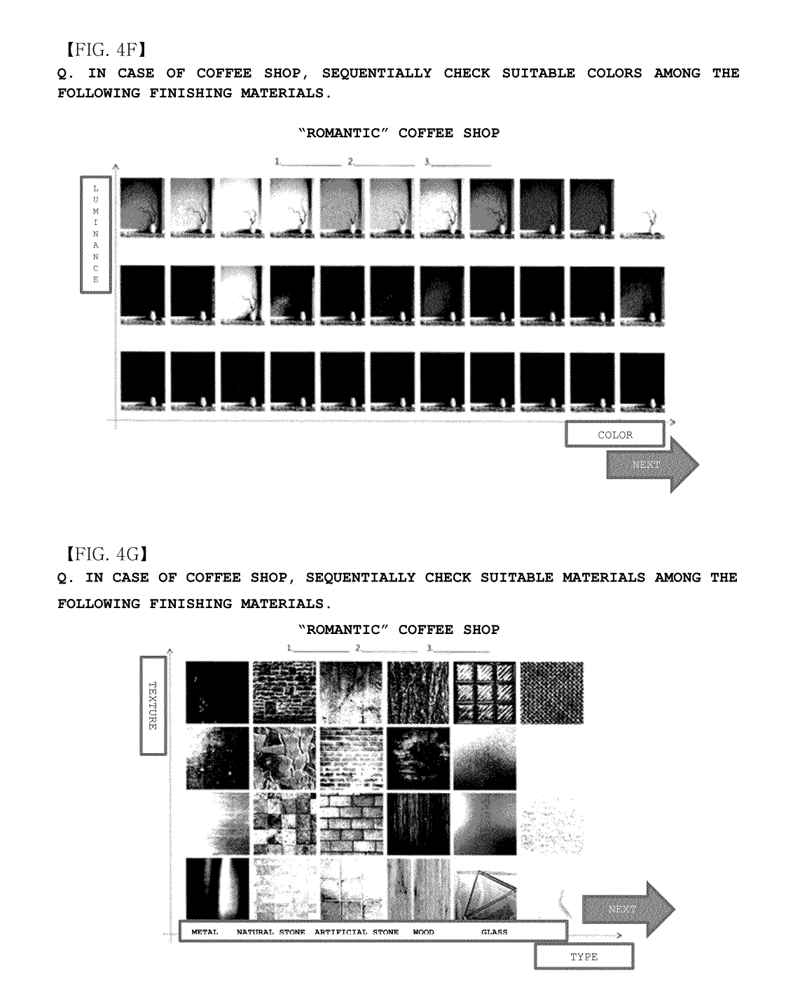

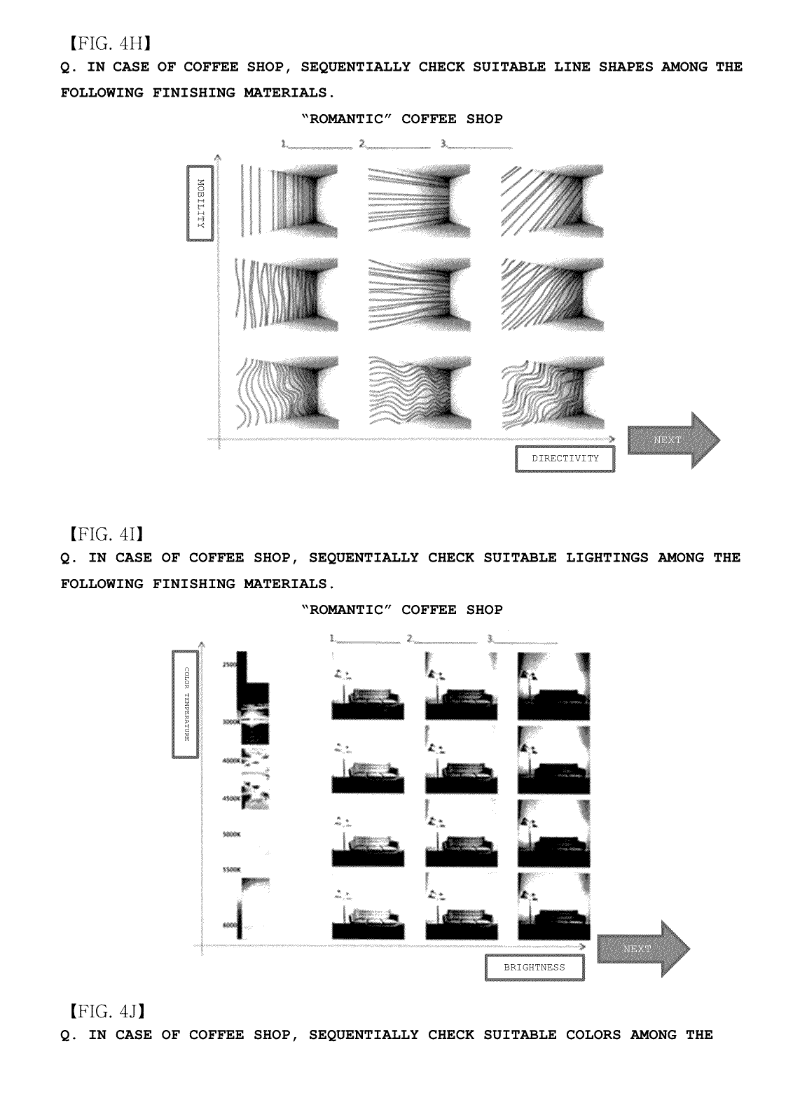

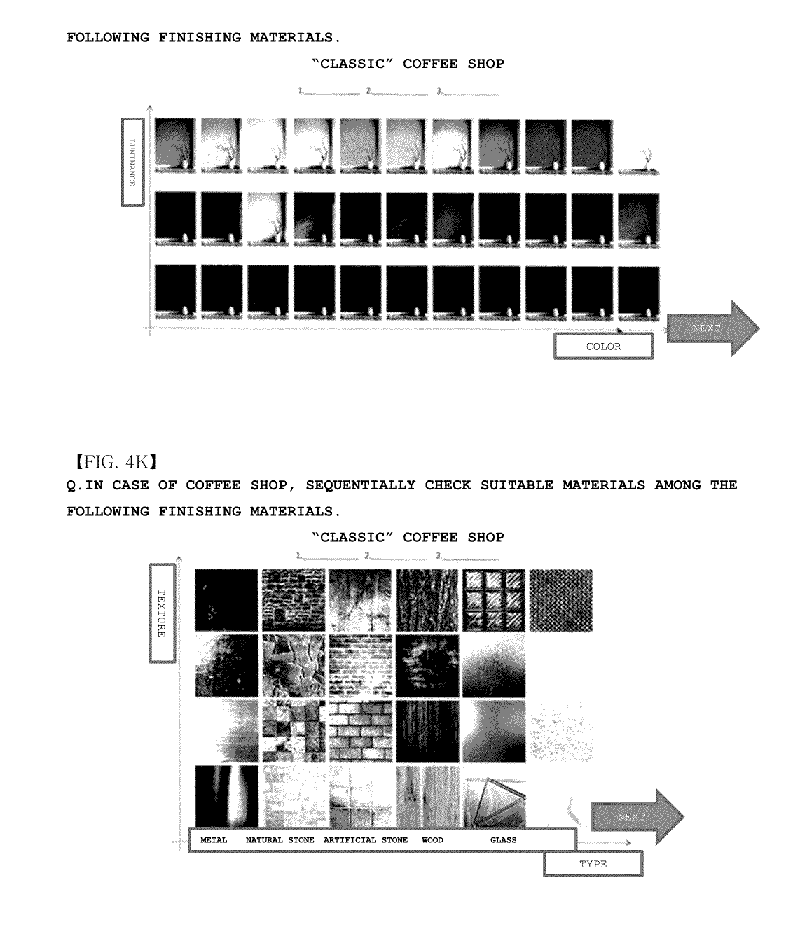

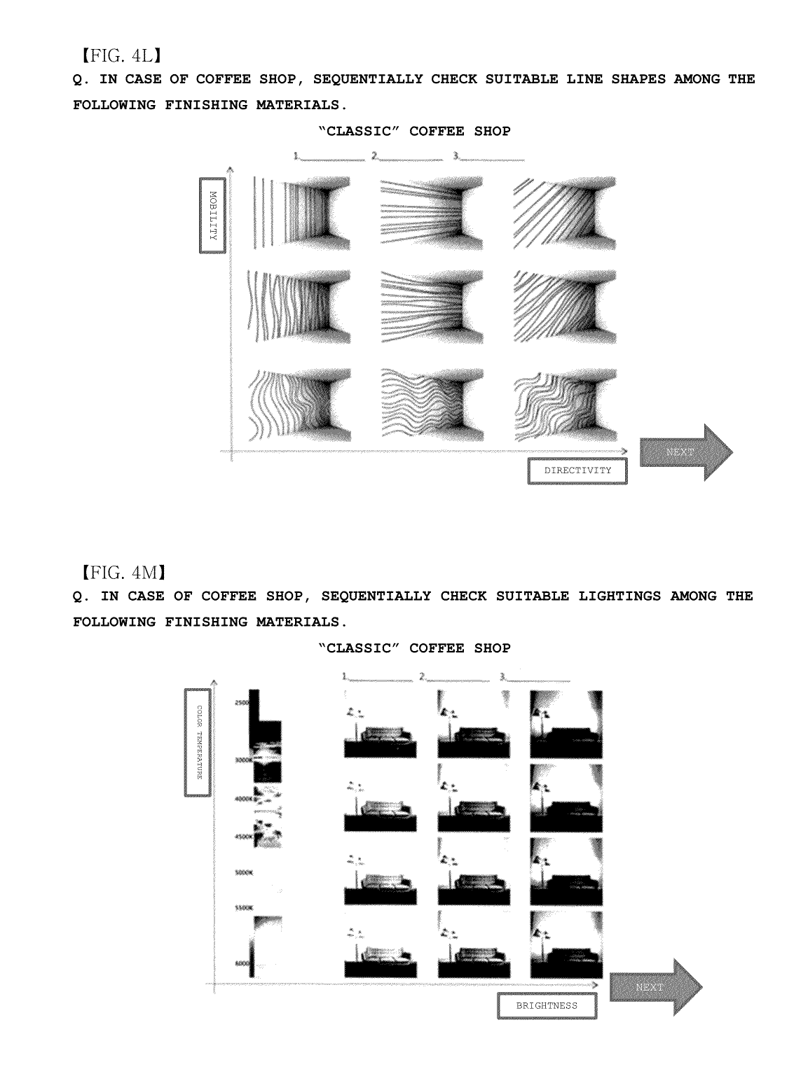

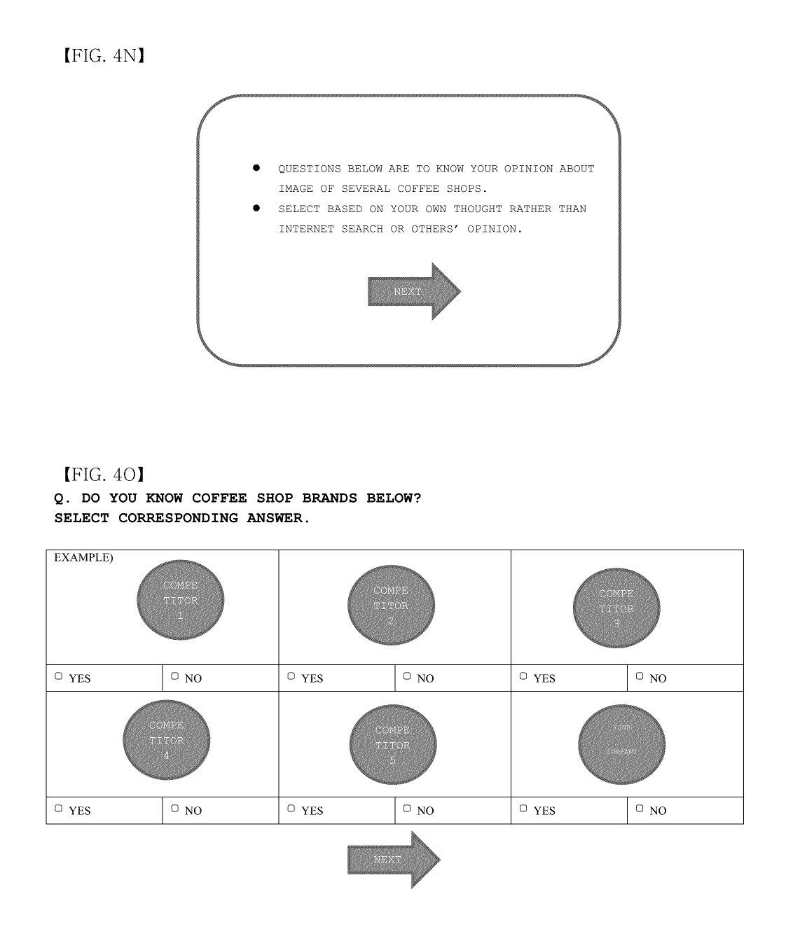

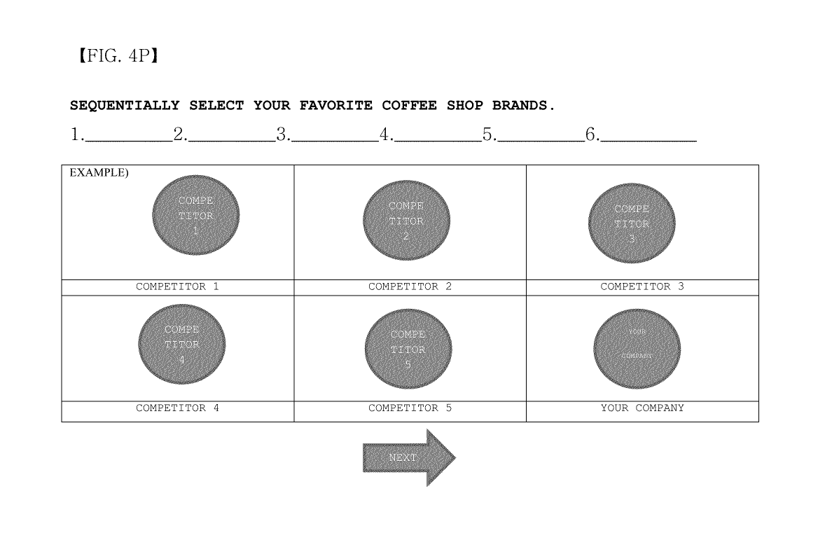

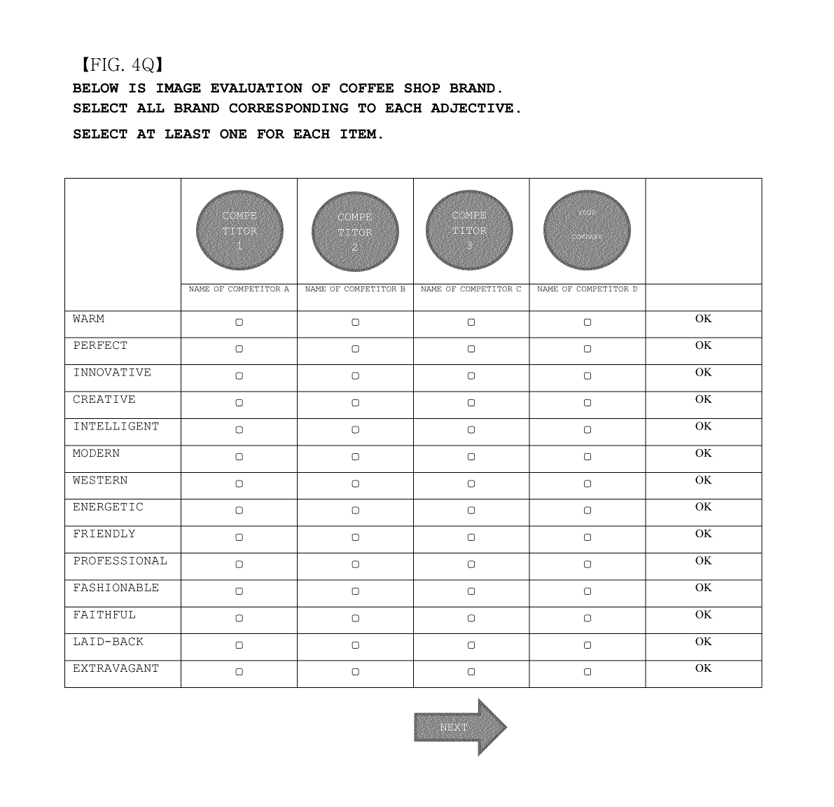

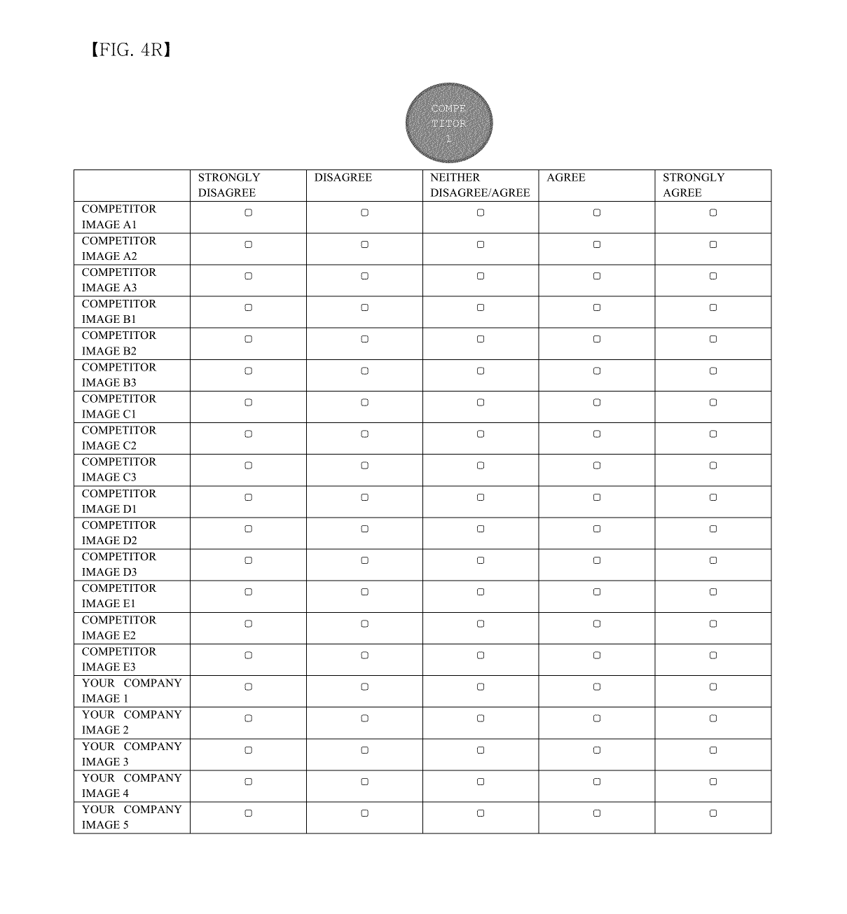

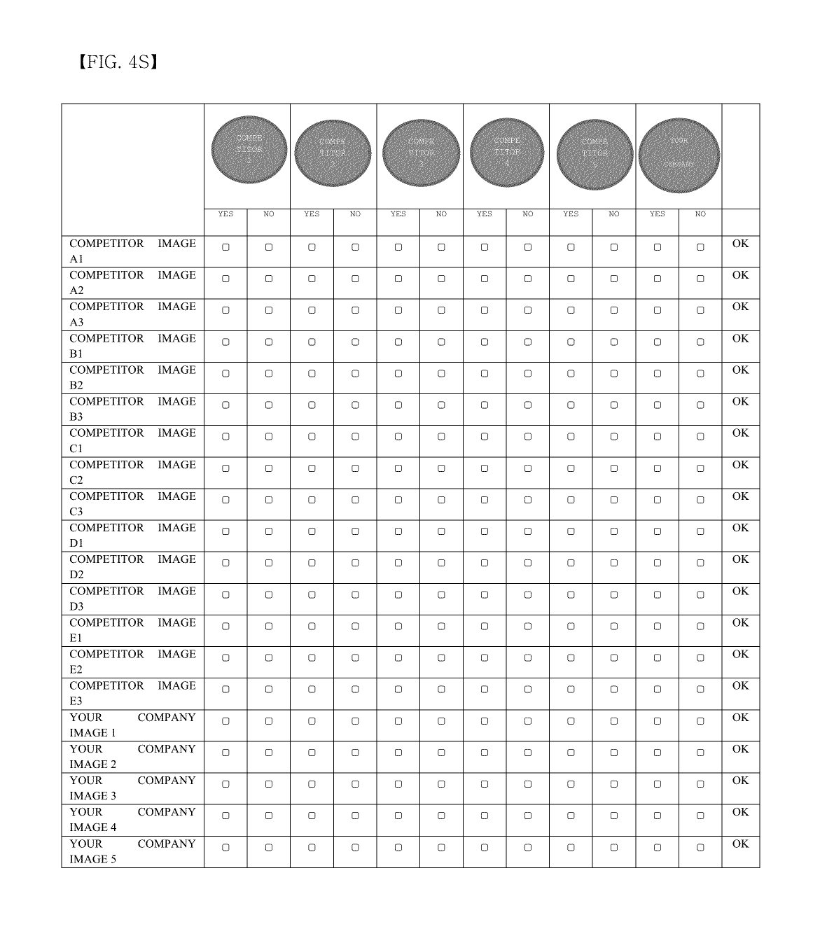

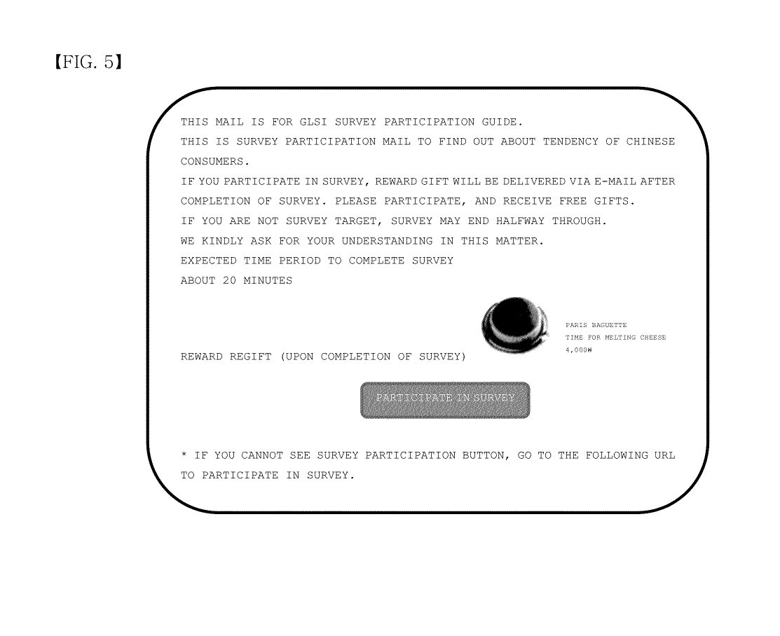

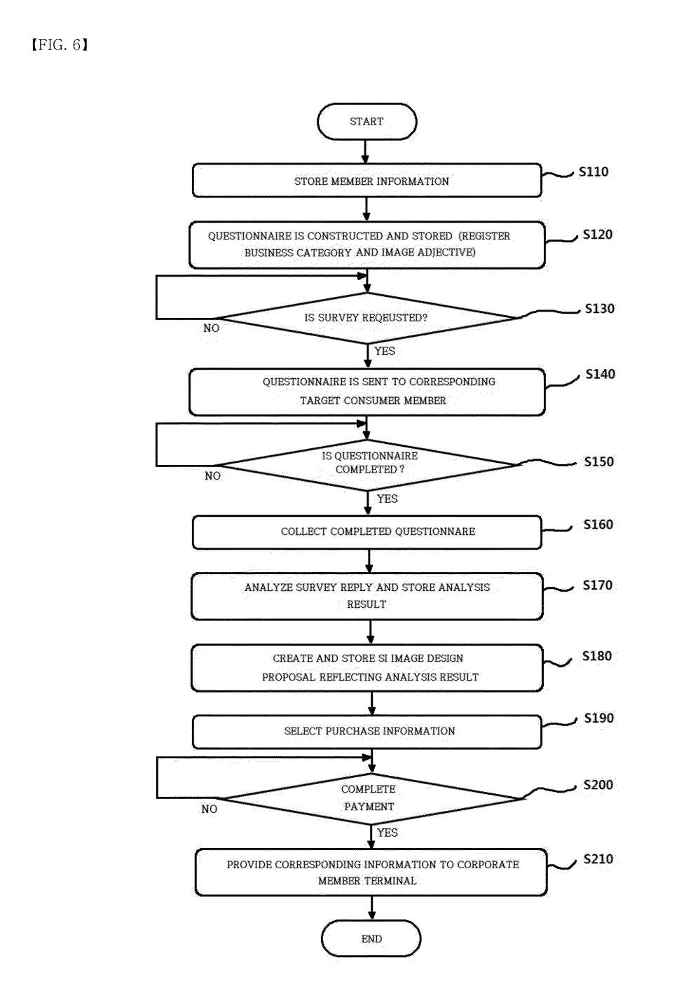

FIGS. 4A to 4S are views illustrating processes of creating a webpage of a questionnaire for researching a consumer demand on an SI image design.

Referring to FIGS. 4F to 4M, a survey item for presenting image adjectives according to a priority pre-registered by the corporate member terminal 120 and a business category are presented so as to select design elements (e.g., color, material, line shape, lightings, and the like) that match the presented image adjective and the business category, according to the priority, corresponding to a predetermined number, is included in a questionnaire.

When the questionnaire sending/collecting module 160 receives a request for a survey from the corporate member terminal 120, the questionnaire sending/collecting module 160 extracts a questionnaire of the corresponding corporate member from the questionnaire database 270, and sends out the questionnaire of the corresponding corporate member to a terminal of a corresponding target consumer member from among the consumer members stored in the registered member database 300. In this instance, the questionnaire sending/collecting module 160 interworks with the member type classification module 190 for filtering the registered members to identify a corresponding target consumer member. In a case in which a target consumer member is not set, the questionnaire construction module 150 may send out a questionnaire to all consumer members stored in the registered member database 300, or may send out a questionnaire to a randomly extracted consumer member. When the questionnaire is completed in the consumer member terminal, the questionnaire sending/collecting module 160 stores the completed questionnaire in the questionnaire database 270 for each corporate member. Although an incomplete questionnaire and a completed questionnaire are stored in the questionnaire database 270 along with each other as described hereinabove, a database for storing completed questionnaires may also be separately provided.

Even in a case of a consumer member not receiving a questionnaire, the consumer member may connect directly to the SI image response research server 130 and may answer the questionnaire. In the case that a consumer member does not correspond to target of the survey service, the survey service may end prior to the completing the questionnaire.

The form of the questionnaire being sent may include a social networking service (SNS), a push alarm message, or the like. In the case of a push alarm message, an application for conducting an SI image response research is installed in the consumer member terminal 110, and whenever a new survey is registered, the application notifies the new registration through the push alarm message.

The image adjective module 170 may perform an editing function such as modifying, adding, and/or deleting the image adjectives presented by the questionnaire construction module 150 as an example to the corporate member terminal 120 by, and may store and manage the presented image adjectives in the image adjective database 280.

The image design element module 180 may perform an editing function such as modifying, adding, and/or deleting the image design elements (refer to FIGS. 4F to 4M) presented to the consumer member terminal 110 on the questionnaire as an example, and may store and manage the presented image design elements in the image design element database 290.

The member type classification module 190 is a module programmed to classify consumer members or corporate members registered in the SI image response research server 130 into types. Consumer members may be classified based on age, gender, marital status, occupation, with/without children, personal income, household income, education level, family member, religion, race, nationality, ethnicity, and the like, and corporate members may be classified based on a business category, and the like. The member type classification module 190 may perform a filtering on survey target members through interworking with the questionnaire sending/collecting module 160.

The display module 200 processes the questionnaire stored in the questionnaire database 270 to be displayed on the consumer member terminal 110 prior to being sent to the consumer member terminal 110.

The analysis module 210 analyzes a reply from the survey service based on the collected questionnaire, and stores the analysis result in the questionnaire reply database 310. In detail, the analysis module 210 may analyze a consumer preference with respect to a design element that matches the business category and the image adjective registered by the corporate member terminal 120, an awareness difference the company and a competitor, an image evaluation of the company and a competitor, and the like. The analysis result stored in the questionnaire reply database 310 as a result of the survey service may be provided to the corporate member terminal 120 by the information dissemination module 230.

The SI image design proposal creation module 220 extracts corresponding ones of the image design elements stored in the image design element database 290 by reflecting a consumer demand based on the analysis result of the analysis module 210, combines and constructs the extracted image design elements so as to create at least one SI image design proposal, and stores the created SI image design proposal in the SI image design proposal database 320. The stored SI image design proposal may be provided to the corporate member terminal 120 by the information dissemination module 230.

The information dissemination module 230 is a module allowing for a purchase of information through interworking with the payment module 250. Herein, the information may be at least one of the SI image design proposals reflecting the analysis result stored in the questionnaire reply database 310, and the reply from the survey service stored in the SI image design proposal database 320.

The point saving module 240 automatically saves a point for each member as a reward in a case of joining membership or participating in a survey, and when one of the saved points is used, deducts the corresponding point. The point saving module 240 operates through interworking with the registered member database 300 and the point saving database 330.

The payment module 250 is a module for requesting and conducting a payment through interworking with the information dissemination module 230. The payment module 250 may be configured to conduct a payment using the saved points.

The CPU 260 exercises an overall control over respective components.

The registered member database 300 stores information on the consumer member and the corporate member registered in the SI image response research server 130. The information on the consumer member may include at least one of gender, age, address, marital status, occupation, with/without children, personal income, household income, education level, family member, religion, race, nationality, ethnicity, e-mail information, SNS information, and contact information. The information on the corporate member may include at least one of business category, business address and name, and business scale. However, the above items of information are only given by way of examples, and other information may be stored in addition thereto.

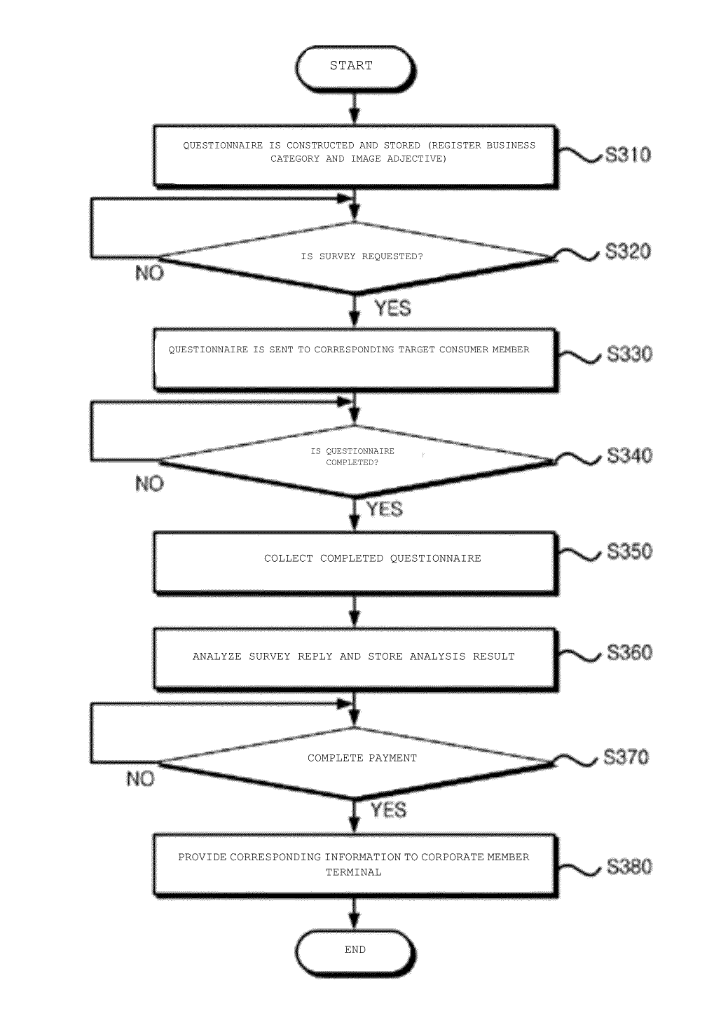

A research method of the SI image response research system having the configuration as described above will be described with reference to FIG. 6.

Referring to FIG. 6, in operation S110, information on a consumer member and a corporate member that have joined the membership of the SI image response research server 130 is stored in the registered member database 300.

The corporate member terminal 120 connected to the SI image response research server 130 through the network 140 constructs and modifies a questionnaire through the questionnaire construction module 150. In this instance, a business category and an image adjective of the corporate member may be registered. The registration of the image adjective is performed by selecting as many as less than a predetermined number of image adjectives from among the plurality of image adjectives managed in the image adjective database 280 or additionally inputting an image adjective. In operation S120, the constructed or modified questionnaire is stored in the questionnaire database 270.

When the questionnaire sending/collecting module 160 receives a request for a survey from the corporate member terminal 120 in operation S130, the questionnaire sending/collecting module 160 extracts a questionnaire of a corresponding corporate member for researching a consumer demand on an SI image design from the questionnaire database 270. The extracted questionnaire includes a survey item for researching a consumer choice for a design element that matches a business category and an image adjective registered by the corporate member terminal 120. The extracted questionnaire is processed to be displayed on the consumer member terminal 110 by the display module 200, and in operation S140, the processed questionnaire is sent to a corresponding target consumer member terminal 110 by the questionnaire sending/collecting module 160. In this instance, the member type classification module 190 for filtering the registered members to identify a corresponding target consumer member interworks with the questionnaire sending/collecting module 160.

When the questionnaire is completed in the consumer member terminal 110 in operation S150, the questionnaire sending/collecting module 160 stores the questionnaire for each corporate member in the questionnaire database 270 in operation S160.

In operation S170, the analysis module 210 analyzes the reply from the survey service based on the collected questionnaire, and stores the analysis result in the questionnaire reply database 310.

The SI image design proposal creation module 220 extracts the image design element stored in the image design element database 290 by reflecting the consumer demand based on the analysis result of the analysis module 210, combines and constructs the extracted image design elements so as to create at least one SI image design proposal, and stores the created SI image design proposal in the SI image design proposal database 320 in operation S180.

At least one of the analysis result stored in the questionnaire reply database 310 and the reply from the survey service stored in the SI image design proposal database 320 may be provided to the corporate member terminal 120 by the information dissemination module 230 based on the selection made by the corporate member in operation S190. In this instance, the information dissemination module 230 allows for a purchase of information through interworking with the payment module 250 in operations S200 and S210.

FIG. 7 is a flowchart illustrating a research method of an SI image response research system according to another exemplary embodiment. However, it may be assumed in the flowchart of FIG. 7 that information on a consumer member and a corporate member that have jointed the membership of the SI image response research server 130 is stored in the registered member database 300 in advance, and thus, the operation S110 of FIG. 6 is omitted herein.

In operation S310, the corporate member terminal 120 connected to the SI image response research server 130 through the network 140 constructs and modifies a questionnaire through the questionnaire construction module 150. In this instance, an SI image design proposal of the corporate member may be registered. The SI image design proposal may be a proposal created by the SI image design proposal creation module 220 as a result of conducting a survey service, a proposal self-created by the corporate member prior to researching a consumer demand, or a proposal self-created by the corporate member by reflecting a reply from a survey service subsequent to researching a consumer demand. The constructed and modified questionnaire is stored in the questionnaire database 270.

In operations S320 and S330, when the questionnaire sending/collecting module 160 receives a request for a survey from the corporate member terminal 120 in operation S320, the questionnaire sending/collecting module 160 extracts a questionnaire of a corresponding corporate member for researching a consumer response to an SI image design proposal from the questionnaire database 270, and sends out the questionnaire of the corresponding corporate member to the consumer member terminal 110 connected to the network 140. The extracted questionnaire is processed to be displayed on the consumer member terminal 110 by the display module 200, and the processed questionnaire is sent to the corresponding target consumer member terminal 110 by the questionnaire sending/collecting module 160 in operation S330. In this instance, the member type classification module 190 for filtering the registered members to identify a corresponding target consumer member interworks with the questionnaire sending/collecting module 160.

When the questionnaire is completed in the consumer member terminal 110 in operation S340, the questionnaire sending/collecting module 160 stores the completed questionnaires in the questionnaire database 270 for each corporate member in operation S350.

In operation S360, the analysis module 210 analyzes the reply from the survey service based on the collected questionnaires, and stores the analysis result in the questionnaire reply database 310.

The analysis result stored in the questionnaire reply database 310 may be provided to the corporate member terminal 120 by the information dissemination module 230. In this instance, the information dissemination module 230 allows for a purchase of information through interworking with the payment module 250 in operations S370 and S380.

Although not illustrated in the flowchart in FIG. 7, the point saving module 240 may save a point for a consumer member that joins membership or participates in a survey.

As set forth above, according to one or more exemplary embodiments, the SI image response research system and the research method thereof may research online a consumer response to or a consumer demand on an SI image design so as to facilitate the development of an SI image design desired by consumers.

1. A store identity (SI) image response research system, comprising:
at least one consumer member terminal;
at least one corporate member terminal; and
an SI image response research server connected to the consumer member terminal and the corporate member terminal, providing a survey service for researching a consumer demand on an SI image design to the consumer member terminal, and providing at least one SI image design proposal created by reflecting a reply from the survey service or a consumer demand based on the reply to a corresponding one of the corporate member terminals,
wherein the survey service provided by the SI image response research server comprises a survey item for researching a consumer choice for a design element which matches a business category and less than a predetermined number of image adjectives representing a store personality which are registered by the corporate member terminal.

2. The SI image response research system of claim 1, wherein the SI image response research server further provides a survey service for researching a consumer response to an SI image design proposal created by the SI image response research server and provided to the corporate member terminal or an SI image design proposal self-created by a corporate member, and
the SI image design proposal self-created by the corporate member is a proposal prior to researching a consumer demand or a proposal reflecting a reply subsequent to researching a consumer demand.

3. The SI image response research system of claim 1, wherein the SI image response research server comprises a questionnaire construction module enabling the corporate member terminal to construct and modify a questionnaire so as to store the questionnaire in a questionnaire database, and register the business category and the image adjective.

4. The SI image response research system of claim 2, wherein the SI image response research server comprises a questionnaire construction module enabling the corporate member terminal to construct and modify a questionnaire so as to store the questionnaire in a questionnaire database, and register the SI image design proposals.

5. The SI image response research system of claim 3 or 4, wherein the SI image response research server further comprises a questionnaire sending/collecting module extracting a questionnaire of a corresponding corporate from the questionnaire database and sending out the questionnaire to a corresponding target consumer member terminal when receiving a request for a survey from the corporate member terminal, and collecting a completed questionnaire when the questionnaire is completed in the consumer member terminal.

6. The SI image response research system of claim 3, wherein the questionnaire construction module presents a plurality of image adjectives so as to allow the corporate member terminal to selectively register the image adjective, and the SI image response research server further comprises an image adjective module performing an editing function such as modifying, adding, and/or deleting the image adjective presented to the corporate member terminal, and storing and managing the plurality of image adjectives presented to the corporate member terminal in an image adjective database.

7. The SI image response research system of claim 1, wherein the SI image response research server presents a plurality of image design elements so as to allow the consumer member terminal to select the image design element at the time of conducting a survey service for researching the consumer demand, and
further comprises an image design element module performing an editing function such as modifying, adding, and/or deleting the plurality of image design elements presented to the consumer member terminal, and storing and managing the plurality of image design elements presented to the consumer member terminal in an image design element database.

8. The SI image response research system of claim 5, wherein the SI image response research server further comprises an analysis module analyzing a reply from the survey service based on the collected questionnaire.

9. The SI image response research system of claim 5, wherein the SI image response research server further comprises a member type classification module classifying consumer members or corporate members stored in a registered member database into types, and filtering the stored members to identify a survey target member through interworking with the questionnaire sending/collecting module.

10. The SI image response research system of claim 3 or 4, wherein the SI image response research server further comprises a display module processing the questionnaire stored in the questionnaire database to be displayed on the consumer member terminal prior to being sent to the consumer member terminal.

11. The SI image response research system of claim 3 or 1, wherein the SI image response research server comprises a point saving module automatically saving a point for each member as a reward in a case of joining membership or participating in a survey, and when one of the saved points is used, deducting the corresponding point.

12. The SI image response research system of claim 1, wherein the SI image response research server comprises an information dissemination module allowing for a purchase of information through interworking with a payment module requesting and conducting a payment, and
the information comprises at least one SI image design proposal created by reflecting a reply from the survey service, or a consumer demand based on the reply.

13. A research method of a store identity (SI) image response research system, the research method comprising:
providing a survey service for researching a consumer demand on an SI image design to a consumer member terminal connected to a network; and
providing at least one SI image design proposal created by reflecting a reply from the survey service or a consumer demand based on the reply to a corresponding corporate member terminal connected to the network,
wherein the survey service comprises a survey item for researching a consumer choice for a design element which matches a business category and less than a predetermined number of image adjectives representing a store personality which are registered by the corporate member terminal.

14. The research method of claim 13, further comprising providing a survey service for researching a consumer response to an SI image design proposal provided to the corporate member terminal or an SI image design proposal self-created by a corporate member,
wherein the SI image design proposal self-created by the corporate member is a proposal prior to researching a consumer demand, or a proposal reflecting a reply subsequent to researching a consumer demand.

15. The research method of claim 13, further comprising enabling the corporate member terminal to construct and modify a questionnaire so as to store the questionnaire in a questionnaire database, and register the business category and the image adjective at the time of constructing the questionnaire.

16. The research method of claim 14, further comprising enabling the corporate member terminal to construct and modify a questionnaire so as to store the questionnaire in a questionnaire database, and register the SI image design proposal at the time of constructing the questionnaire.

17. The research method of claim 15 or 16, wherein the providing of the survey service comprises:
extracting a questionnaire of a corresponding corporate from the questionnaire database and sending out the questionnaire to a corresponding target consumer member terminal when receiving a request for a survey from the corporate member terminal; and
collecting a completed questionnaire when the questionnaire is completed in the consumer member terminal.

18. The research method of claim 15, further comprising presenting a plurality of image adjectives so as to allow the corporate member terminal to selectively register the image adjective, at the time of constructing the questionnaire.

19. The research method of claim 13, further comprising presenting a plurality of image design elements so as to allow the consumer member terminal to selectively register the image design element, at the time of conducting the survey service for researching the consumer demand.

20. The research method of claim 17, further comprising analyzing a reply from the survey service based on the collected questionnaire.

21. The research method of claim 17, further comprising classifying registered consumer members or corporate members into types, and filtering the registered members to identify a survey target member.

22. The research method of claim 15 or 16, further comprising processing the questionnaire stored in the questionnaire database to be displayed on the consumer member terminal prior to being sent to the consumer member terminal.

23. The research method of claim 13, further comprising automatically saving a point for each member by providing the point as a reward in a case of joining membership or participating in a survey, and when one of the saved points is used, deducting the corresponding point.

24. The research method of claim 13, further comprising requesting and conducting a payment in a case of providing, to the corporate member terminal, at least one SI image design proposal created by reflecting a reply from the survey service, or a consumer demand based on the reply.
